(19) United States
(12) Patent Application Publication
(10) Pub. No.: US 2023/0229550 A1
(43) Pub. Date: Jul. 20, 2023

(54) DETECTING METRICS INDICATIVE OF OPERATIONAL CHARACTERISTICS OF A NETWORK AND IDENTIFYING AND CONTROLLING BASED ON DETECTED ANOMALIES

(71) Applicant: Microsoft Technology Licensing, LLC, Redmond, WA (US)

(72) Inventors: Liting ZHAO, Jiangsu (CN); Srinivasachakrapani KOTIPALLI, Sammamish, WA (US); Zhenguo YANG, Suzhou (CN); Bradley RUTKOWSKI, Woodinville, WA (US)

(21) Appl. No.: 18/002,595

(22) PCT Filed: Jul. 2, 2020
(86) PCT No.: PCT/CN2020/099844

§ 371 Date: Dec. 20, 2022

(51) Int. Cl. G06F 11/07

(52) U.S. Cl. CPC G06F 11/079; G06F 11/0709

(57) ABSTRACT

A machine learning anomaly detection system receives a time series of metrics indicative of operational characteristics of a computing system architecture. A distribution of the metrics values is identified and a volume of metrics detected during a current evaluation period is identified. A dynamic anomaly detection threshold is generated, based upon the distribution and the volume of detected metrics. Metric values from the current evaluation period are compared to the dynamic anomaly detection threshold to determine whether the metric values in the current evaluation period are anomalous. If so, an action signal is generated.

### BACKGROUND

Computer systems are currently in wide use. Some computer systems host services that can be accessed by client or tenant devices over a network. Some systems detect metrics that indicate certain characteristics regarding the interaction of the service with the client or tenant devices. These characteristics can be detected both on the client side and on the server side by various different types of detectors. The detectors can detect such things as the success rate with which client systems connect to service, various different latencies, the network path taken by requests, etc. The detected metrics can be aggregated into a time series of signals that characterize the operational characteristics of the architecture.

Some systems perform signal processing on the time series of signals to detect operational problems in the architecture. For instance, some signal processing can be used to identify anomalies in the time series of signals in order to identify anomalous behaviors in the operational characteristics of the computing system.

In the signal processing systems, some models attempt to predict or identify the anomalies based upon deviations from normal metric patterns.

The discussion above is merely provided for general background information and is not intended to be used as an aid in determining the scope of the claimed subject matter.

### SUMMARY

A machine learning anomaly detection system receives a time series of metrics indicative of operational characteristics of a computing system architecture. A distribution of the metrics values is identified and a volume of metrics detected during a current evaluation period is identified. A dynamic anomaly detection threshold is generated, based upon the distribution and the volume of detected metrics. Metric values from the current evaluation period are compared to the dynamic anomaly detection threshold to determine whether the metric values in the current evaluation period are anomalous. If so, an action signal is generated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of computing system architecture.

FIG. 2 is a block diagram showing one example of a machine learning anomaly detection system, in more detail.

FIGS. 3A and 3B (collectively referred to herein as FIG. 3) illustrate a flow diagram showing one example of the operation of the architecture illustrated in FIG. 1 in identifying anomalies in the operation of the computing system architecture.

FIGS. 4A and 4B (collectively referred to herein as FIG. 4) show a flow diagram illustrating one example of the operation of the machine learning anomaly detection system shown in FIGS. 1 and 2, in identifying anomalies, in more detail.

FIG. 5 shows one example of a dynamic anomaly detection threshold.

FIG. 6 shows one example of the results of applying the dynamic anomaly detection threshold.

FIG. 7 is a block diagram showing one example of the computing system architecture illustrated in FIG. 1, deployed in a cloud computing architecture.

FIG. 8 is a block diagram showing one example of a computing environment that can be used in the architectures shown in the previous figures.

### DETAILED DESCRIPTION

As discussed above, some systems have attempted to detect events that are indicative of operational characteristics of a computing system architecture. The detected events can be represented by metric values. A time series of metric values is generated based upon detections of the events, over time. Some systems have attempted to identify anomalies in the time series of detected events, and this can be difficult because the patterns of the time series of metric values can change, naturally, over time.

For example, different time series may have different patterns, such as seasonal patterns, stable patterns and unstable patterns. Similarly, even known patterns of a time series can change over time.

Some systems identify a normal distribution of metric values that characterize the operation of a computing system. The normal distribution may be identified over a set of historical values. A normal distribution means that most of the data values aggregate around a mean value in a generally symmetric fashion. Values become less and less likely to occur the further they are from the mean value. The standard deviation of a normal distribution defines how far the normal distribution is spread around the mean value. In a normally distributed set of metric values, approximately 68% of all values fall between one standard deviation on either side of the mean value. Approximately 95% of all values fall within two standard deviations on either side of the mean value, and approximately 99.7% of all values fall within three standard deviations on either side of the mean value.

For purposes of the present discussion, it is assumed that the metric values which characterize the operational characteristics (indicated by the detected events) of the computing system architecture are normally distributed. Thus, the time series of metric values conform generally to the rules discussed above with respect to a normal distribution.

As an example, assume that the detected operational characteristic of a computing system architecture is the success rate at which network connectivity requests are made. This operational characteristic (connection success rate) can be identified by detecting requests for connection to a service (a request event) and successful or failed connection (a connection or failed connection event). For instance, if a client computing system attempts to connect to a service computing system, the detected metric indicates whether that requested connection is successful. The time series of values indicative of the network connection success rate is roughly normally distributed. Thus, an anomaly threshold can be identified by calculating the mean value and standard deviation of the historical data distribution, The mean and standard deviation can be used to distinguish between normal and outlier metric values (e.g., between whether the connection success rate is normal or anomalous). Because the distribution of data can change over time, the present description thus proceeds with respect to using a sliding historical window over which the mean and standard deviation of the normal distribution are calculated. Depending on the events represented by the particular time series of metrics, the window can slide at different frequencies. For instance, it may slide every 5 minutes, every hour, every day, or it may slide based on the frequency of data changes, or in other ways.

The present discussion also recognizes that the anomaly threshold should be set based upon the volume of metric values under consideration. For instance, again assume that the metric under analysis is the network connection success rate. If the data under analysis was taken in the middle of the night, the number of requests is likely very small compared to the number of requests during business hours. Therefore, even a relatively small number of connectivity request failures would result in a large drop in the connection in success rate, because the total number of requests is very small.

The present discussion thus proceeds with respect to setting a dynamic anomaly detection threshold based upon volume. The anomaly detection threshold discussed herein varies dynamically as a function of the volume of the metrics under analysis. The anomaly threshold is set more strictly (higher) with larger volumes. This is because a relatively small reduction in the number of successful requests, at a large request volume, will not be as noticeable, while a relatively small number of unsuccessful requests will have more impact on the connection success rate when the volume of requests is smaller. Therefore, the anomaly detection threshold is dynamic and is set higher, when the volumes are higher, and lower, when the volumes are lower.

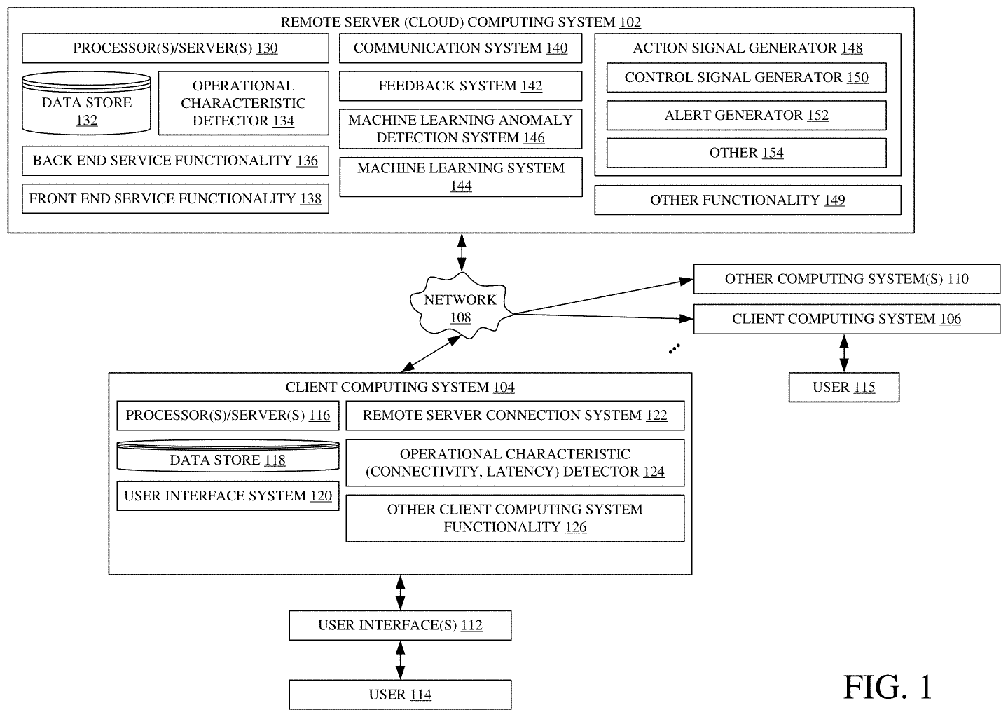

FIG. 1 is a block diagram showing one example of a computing system architecture 100. Architecture 100 includes remote server (cloud) computing system 102, and a plurality of client computing systems 104-106. Client computing systems 104 and 106 are shown accessing remote server computing system 102 over network 108. In one example, remote server computing system 102 hosts an application or service that is accessed by the client computing systems 104-106 over network 108. Therefore, network 108 can be a wide area network, a local area network, a near field communication network, a cellular communication network, or any of a wide variety of other networks or combinations of networks. FIG. 1 also shows that the items connected to network 108 can access, and/or be accessed by, other computing systems 110 as well.

FIG. 1 also shows that client computing system 104 generates one or more user interfaces 112 for interaction by user 114. User 114 illustratively interacts with user interfaces 112 in order to control and manipulate client computing system 104 and some parts of remote server computing system 102.

Client computing system 106 can also illustratively be accessed by user 115. User 115 can control client computing system 106 and some portions of remote server computing system 102.

Client computing systems 104 and 106 can be similar or different. It is assumed for the sake of the present discussion that they are similar, so that only client computing system 104 is described in more detail. Client computing system 104 can include one or more processors or servers 116, data store 118, user interface system 120, remote server connection system 122, operational characteristic (connectivity, latency, etc.) detector 124, and it can include a wide variety of other client computing system functionality 126.

In the example discussed herein, client computing system 104 includes remote server connection system 122 which establishes connections with remote server computing system 102. Operational characteristic detector 124 detects events that indicate various operational characteristics (or from which those operational characteristics can be derived) of client computing system 104 and architecture 100. It can intermittently transmit those characteristics (or metric values indicative of those characteristics) to remote server computing system 102 over network 108. For instance, detector 124 can detect the connection success rate of client computing system 104 with remote server computing system 102. The connection success rate can be characterized by detecting events, and generating a metric indicative of those events. By way of example, detector 124 can detect requests in which system 122 requests a connection with computing system 102. Detector 124 can also detect when the requests are successful and determine the percent of times that remote server connection system 122 requests a connection to remote server computing system 102 relative to the number of times that the request is successful, and a connection is actually made. Detector 124 may characterize this as a percentage value indicative of the percentage of time that the connection request is successful (the connection success rate).

Detector 124 can also detect other metrics, such as latency (the time between when a request is sent to remote server computing system 102 and when a response is received). The detector 124 can also generate a metric value (which may be a time value) indicative of the average or per request latencies experienced by client computing system 104.

Detector 124 can detect a wide variety of other operational characteristics, or events from which operational characteristics can be derived, as well. These may include such things as the route through network 108 that requests take, to remote server computing system 102, as well as a wide variety of other events or operational characteristics.

User interface system 120 illustratively generates user interfaces 112 and detects user interactions with those user interfaces 112. It can provide an indication of the detected interactions to other items in client computing system 104 and remote server computing system 102.

Remote server computing system 102 illustratively includes one or more processors or servers 130, data store 132, operational characteristic detector 134, service back end functionality 136, service front end functionality 138, communication system 140, feedback system 142, machine learning system 144, machine learning anomaly detection system 146, action signal generator 148 and it can include other functionality 149 as well. Action signal generator 148, itself, can include control signal generator 150, alert generator 152, and it can include a wide variety of other items 154. Before describing the overall operation of architecture 100, a brief description of some of the items in remote server computing system 102, and their operation, will first be provided.

Data store 132 can store client data for various clients or tenants. Service front end functionality 138 can expose application programming interfaces, or other interfaces, that can be accessed by the client computing systems 104-106 (or client components of the service hosted by system 102). Service front end functionality 138 can pass requests to service back end functionality 136 which performs actions and accesses and manipulates user data in data store 132, based upon the requests.

Like operational characteristic detector 124 on client computing system 104, operational characteristic detector 134 can detect operational characteristics, or events from which operational characteristics can be derived, and generate metrics indicative of those characteristics, from the perspective of remote server computing system 102. Thus, detector 134 can detect various connectivity issues (such as the amount of times a connection was dropped by a client computing system), various latencies, among a wide variety of events or operational characteristics.

Communication system 140 can enable communication among the various items of remote server computing system 102. It can facilitate communications with other items in architecture 100 as well.

Machine learning anomaly detection system 146 illustratively receives the metrics indicative of the detected operational characteristics from operational characteristics detector 134 and from the various operational characteristic detectors 124 on client computing systems 104-106. System 146 illustratively receives those metric values over time (or receives a set of metric values that have been aggregated or detected over time), as a time series of values. System 146 detects anomalies in those values, which indicate anomalies in the operating characteristics that are sensed and represented by those values. System 146 detects anomalies by generating a dynamic anomaly detection threshold using a dynamic function that yields a threshold value that varies with volume. This is described in greater detail below. System 146 compares a current value (or representative value) against the threshold and generates an output indicative of the detected anomalies to action signal generator 148.

Action signal generator 148 generates action signals based upon the detected anomalies. For instance, control signal generator 150 can generate control signals to automatically perform remediation steps to correct anomalous operational characteristics. By way of example, if the anomaly indicates a relatively low connection success rate with a particular client computing system 104 or a set of client computing systems, then control signal generator 150 may generate control signals to automatically allocate more resources to a service region that serves client computing system 104. It may allocate more computing resources (in terms of virtual machines or other computing resources) to requests received from client computing system 104 as well.

Alert generator 152 can generate an alert signal that is provided to engineers or other users (such as at other computing systems 110). Those users then can initiate investigations and take remedial actions based upon the alert.

It may be that anomaly detection system 146 erroneously detects anomalies where none actually occurred, or erroneously fails to detect anomalous behavior. In that case, feedback can be provided through feedback system 142 (e.g., by the engineers or other users of computing system 110) indicating whether anomaly detection system 146 failed to detect anomalous behavior or detected anomalous behavior where none actually existed. This can be provided to machine learning system 144 which can perform machine learning operations to adjust the dynamic anomaly detection function used to generate the dynamic anomaly detection threshold that is being used by anomaly detection system 146 to detect anomalous behavior. The machine learning can be performed on other values and mechanisms used by anomaly detection system 146 to improve its performance as well. Some of these are described in greater detail below.

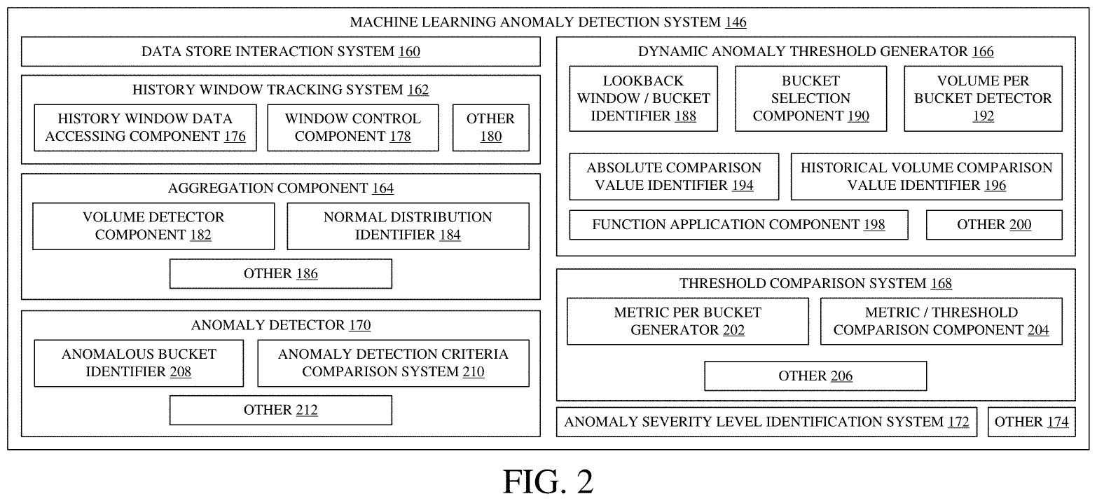

FIG. 2 is a block diagram showing one example of machine learning anomaly detection system 146, in more detail. FIG. 2 shows that machine learning anomaly detection system 146 illustratively includes data store interaction system 160, history window tracking system 162, aggregation component 164, dynamic anomaly threshold generator 166, threshold comparison system 168, anomaly detector 170, anomaly severity level identification system 172, and it can include other items 174. History window tracking system 162, itself, can include history window data accessing component 176, window control component 178 and it can include other items 180. Aggregation component 164 can, itself, include volume detector component 182, normal distribution identifier 184, and it can include other items 186. Dynamic anomaly threshold generator 166 can include lookback window/bucket identifier 188, bucket selection component 190, volume per bucket detector 192, absolute comparison value identifier 194, historical volume comparison identifier 196, function application component 198, and it can include other items 200. Threshold comparison system 168 illustratively includes metric per bucket generator 202, metric/threshold comparison component 204, and it can include other items 206. Anomaly detector 170 can, itself, include anomalous bucket identifier 208, anomaly detection criteria comparison system 210, and it can include other items 212. A brief description of some of the items in machine learning anomaly detection system 146, and their operation, will now be provided.

Data store interaction system 160 illustratively interacts with data store 132 or other data stores where information is stored that is used by machine learning anomaly detection system 146 to detect anomalies. History window tracking system 162 illustratively identifies a history window over which a normal distribution will be identified. History window data accessing component 176 accesses the metric values in the history window, and window control component 178 controls whether, and when, the window is to be moved forward in time. For instance, the data distribution for the metric values may change over time. Thus, the history window over which the normal distribution is identified is slid forward in time so that only a relatively recent set of data is used to identify the normal distribution. The history window can be slid forward in time based on a wide variety of different criteria. For instance, if the data patterns change relatively quickly, it may be slid forward every few minutes, every hour, or every day. If the data patterns change more slowly, and the volume of data is lower, the window may be slid more slowly still. Window control component 178 can also determine how quickly the data is changing. If it changes more quickly, then the window may be slid more frequently. If the data changes less quickly, then the window may be slid less frequently.

Aggregation component 164 aggregates the data in the history window so that the normal distribution can be identified. Volume detector component 182 identifies the volume of data in the history window to ensure that sufficient data has been aggregated within the window. Normal distribution identifier 184 then identifies the normal distribution (by mean and standard deviation) of the data in the history window.

Dynamic anomaly threshold generator 166 then generates a dynamic anomaly detection threshold against which a current metric value (or representative metric value) can be compared to determine whether the operational characteristic represented by the metric value is anomalous. This would indicate that the computing system may be operating in an anomalous way.

In order to identify anomalous behavior, in one example, a single metric value is not compared to the dynamic anomaly detection threshold. Instead, a representative value, that represents a number of metrics values within a time window (a lookback window) is compared to the dynamic anomaly detection threshold. Thus, in one example, lookback window/bucket identifier 188 identifies a relatively current set of data and defines that set of data as a lookback widow (or the window under analysis). The lookback window is then divided into time buckets (or temporal segments) that each contain values for the time series of metrics within a time range, within the lookback window. A representative metric value is generated for each of the buckets. For instance, if the metric values represent connection success rate, then an average of the connection success rate for the metric values in a bucket may be calculated. It is this value which is then compared against the dynamic anomaly detection threshold that is derived from the normal distribution. Thus, lookback window/bucket identifier 188 identifies the lookback window (the timespan that is currently under analysis), and divides that lookback window into buckets (or temporal segments) which will each be separately analyzed. Bucket selection component 190 selects one of the buckets and volume per bucket detector 192 identifies the volume (e.g., the number of metrics) in that bucket. Absolute comparison value identifier 194 identifies an absolute comparison value, and historical volume comparison value identifier 196 identifies a historical (or relative) comparison value. Function application component 198 then applies a dynamic function to generate the dynamic anomaly detection threshold.

More specifically, assume that the dynamic function that is used to generate the dynamic anomaly detection threshold is that illustrated in Equation 1 below:

DynamicThreshold=μ−ƒ(vol)*σ Eq. 1

where μ is the mean of the normal distribution

σ is the standard deviation, and

ƒ(vol) is the dynamic function used to dynamically adjust the anomaly detection threshold based on volume.

As described herein, one goal is that, with larger request volumes, the value of ƒ(vol) will become smaller. This leads to a higher dynamic anomaly detection threshold value for larger volumes. Similarly, as the request volume under analysis decreases, the value of ƒ(vol) increases, leading to a lower anomaly detection threshold.

In one example, ƒ(vol) is identified as follows:

$$f ( v o l ) = c + {e}^{- \frac{vol}{b}} + {e}^{- \frac{vol}{Mean ( last\_week \_vol )}} \qquad Eq . 2$$

Where c is a constant value;

b is a constant value which can be derived empirically from historical experience, or in other ways;

Mean (last_week_vol) is a mean value of volume from a relatively recent historical time period, in this case, the previous week; and

vol is the total volume of requests in the bucket under analysis.

From Equation 2, it can be seen that the current volume in the bucket under analysis is comared to an absolute value, b, by the term set out in Equation 3:

$${e}^{- \frac{vol}{b}} \qquad Eq . 3$$

Also, the current volume is compared to a relative term to determine whether it is high or low relative to a recent value (the mean volume level of the last week) with the term Equation 4:

$${e}^{- \frac{vol}{Mean ( last\_week \_vol )}} \qquad Eq . 4$$

Thus, function application component 198 applies the functionality ƒ(vol) in the dynamic threshold Equation 1 to obtain a value for the dynamic anomaly detection threshold.

Threshold comparison system 168 then compares the representative value corresponding to the current bucket against the dynamic anomaly detection threshold to determine whether an anomaly exists. More specifically, in one example metric per bucket generator 202 generates the representative value of the metric being analyzed for the selected bucket. As indicated above, this may be an average value, or another value. Metric/threshold comparison component 204 then compares that metric against the dynamic anomaly detection threshold that was generated by generator 166. This comparison indicates whether the representative metric meets the threshold. If not, anomaly detector 170 uses anomalous bucket identifier 208 to identify the bucket of values under analysis as containing an anomaly. The comparison is generated for each of the buckets in the lookback window.

Anomaly detection criteria comparison system 210 accesses anomaly detection criteria and determines whether an anomaly exists, given those criteria. For instance, if the system wishes to identify any anomalous bucket as an anomaly, then if even a single bucket in the lookback window is labeled as an anomalous, system 210 generates an output indicating that an anomaly existed in one of the buckets. However, if the criteria indicate that an anomaly is only to be identified if it has persisted for a number of sequential buckets, or for a plurality of buckets within a lookback window, or for some other quantity of buckets, then system 210 determines whether those criteria are met. If so, system 210 outputs an indication that identifies the type of anomalous behavior.

Anomaly severity level identification system 172 detects whether the anomaly is a high grade anomaly, a low grade anomaly, etc. The classification can be used by action signal generator 148 (shown in FIG. 1) in identifying which particular action signals to generate.

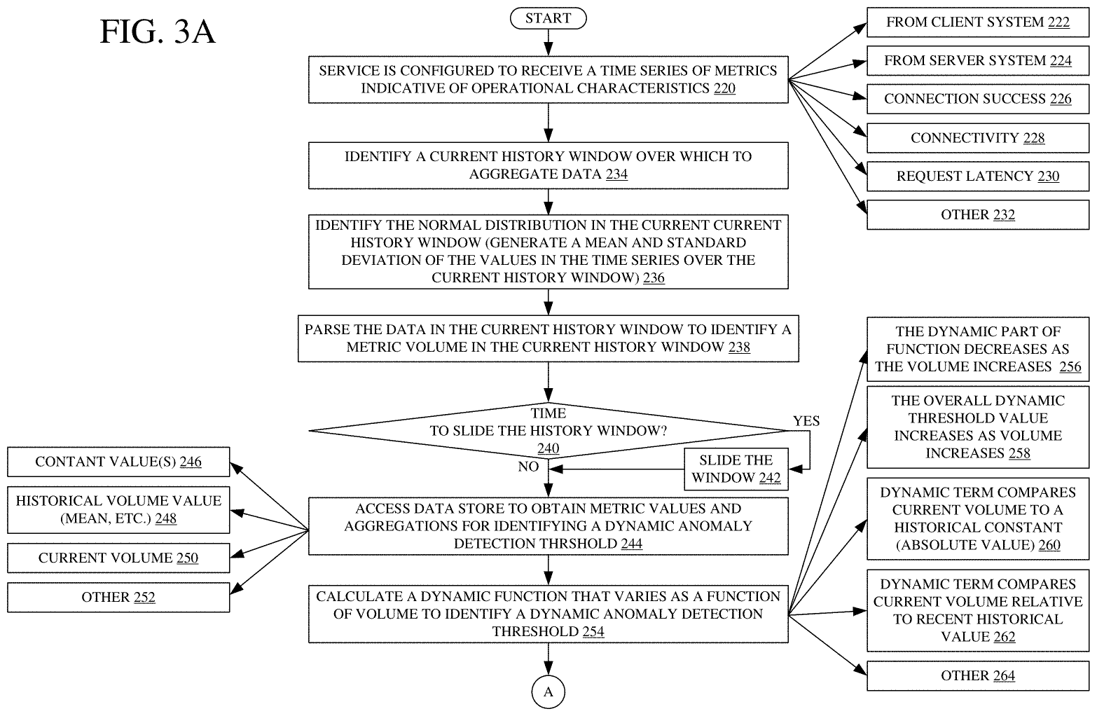

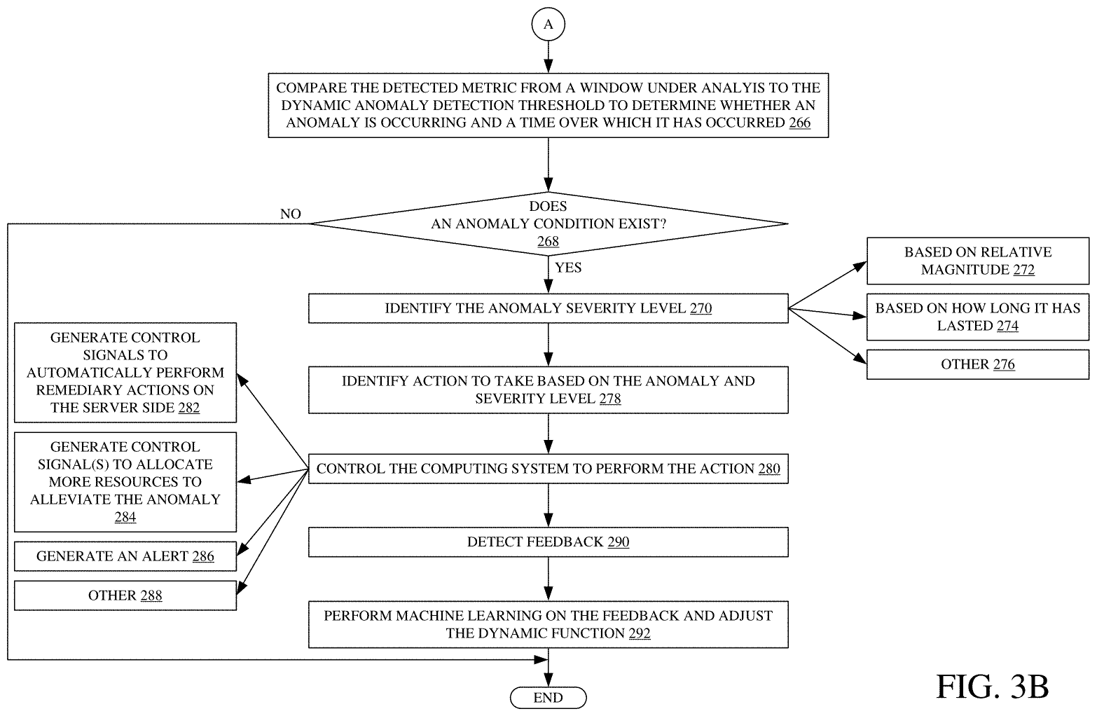

FIGS. 3A and 3B (collectively referred to herein as FIG. 3) show a flow diagram illustrating one example of the operation of computing system architecture 100 in obtaining time series data indicative of the operational characteristics of architecture 100, identifying anomalies in those time series, and generating action signals to perform an action based upon a detected anomaly. It is first assumed that a service computing system 102 is configured to receive a time series of metrics indicative of operational characteristics of the architecture. This is indicated by block 220 in the flow diagram of FIG. 3.

In one example, time series metrics indicative of operational characteristics detected at the client computing system 104 can be received at the remote server computing system 102. This is indicated by block 222. For instance, operational characteristic detector 124 can detect operational characteristics from the point of view of client computing system 104 and provide them to machine learning anomaly detection system 146. Similarly, a time series of metrics can be obtained from the service side. For instance, operational characteristic detector 134 on computing system 102 can detect operational characteristics of the computing system architecture from the perspective of the service. These can also be provided to machine learning anomaly detection system 146. This is indicated by block 224. In one example, the operational characteristics that are detected include connection success rate as indicated by block 226. They can include other connectivity characteristics 228, latency 230 corresponding to different requests, and they can include a wide variety of other items 232.

Window control component 178 (in machine learning anomaly detection system 146) then identifies a history window over which to aggregate data in order to identify the normal distribution of the data corresponding to the received time series of metrics. This is indicated by block 234. As discussed above, the history window may be identified based on a variety of different criteria.

History window data accessing component 176 then accesses the values in the time series of metrics that have been received within that history window, and aggregates that information so that the normal distribution can be generated. Normal distribution identifier 184 then identifies the normal distribution in the current history window, based upon the aggregated data. Identifier 184 can generate a mean and standard deviation of the values in the time series over the current history window. This is indicated by block 236 in the flow diagram of FIG. 3.

Volume detector 182 can parse the data in the current history window to identify a volume of metric values that are in the current history window. This is indicated by block 238. This can be done to ensure adequate volume is represented in the history window to obtain a meaningful normal distribution.

Also, as discussed above, the current history window may slide forward in time so that it is encompassing relevant data (relatively recent data). Thus, window control component 178 can determine whether it is time to slide the history window forward. Also, as briefly discussed above, determining when to slide the history window can be based on a time period (such minutes, hours, days, etc.). It can be based on other criteria as well, such the frequency of the data changes. Determining whether to slide the window is indicated by block 240 in the flow diagram of FIG. 3 and, sliding the window forward is indicated by block 242.

Dynamic anomaly threshold generator 166 then accesses the data store to obtain metric values and aggregations for identifying the dynamic anomaly detection threshold. This is indicated by block 244 in the flow diagram of FIG. 3. For instance, absolute comparison identifier 194 obtains the constant values c and b (shown in Equation 2) as indicated by block 246. Historical volume comparison value identifier 196 can obtain the historical volume value (such as the Mean (last_week_vol) value from Equation 2). This is indicated by block 248. Volume per bucket detector 192 can identify the volume in the current bucket under analysis. This is indicated by block 250. Other information can be obtained that can be used to calculate the dynamic anomaly detection threshold as well. This is indicated by block 252.

Function application component 198 then calculates a dynamic function that varies as a function of volume, in order to identify the dynamic anomaly detection threshold. This is indicated by block 254 in the flow diagram of FIG. 3. For instance, it can calculate the dynamic function ƒ(vol) as indicated in Equation 2, and then it can calculate the dynamic threshold as indicated in Equation 1.

In one example, the dynamic function ƒ(vol) decreases as the volume value increases. This is indicated by block 256. Also, the overall dynamic threshold value generated by Equation 1 illustratively increases as volume increases to impose a more strict standard with greater volumes. This is indicated by block 258. In one example, the dynamic term ƒ(vol) can compare the current volume to a historical constant value (b) as indicated by Equation 3, and the dynamic term can compare the current value to a relative recent historical value of volume as indicated by Equation 4. These steps are indicated by blocks 260 and 262 in the flow diagram of FIG. 3. Calculating the dynamic anomaly detection threshold can be done in other ways as well, and this is indicated by block 264 in the flow diagram of FIG. 3.

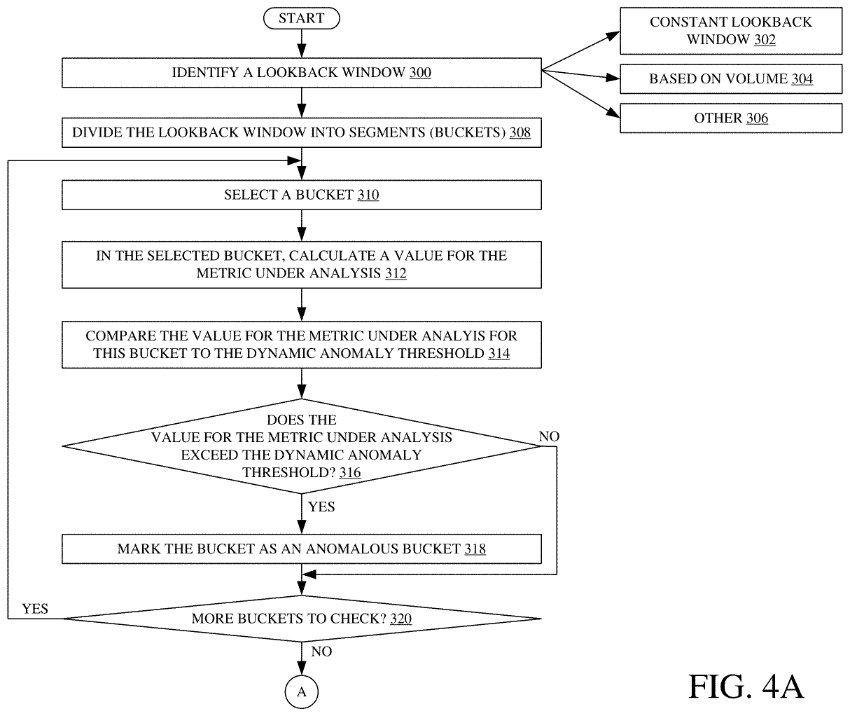

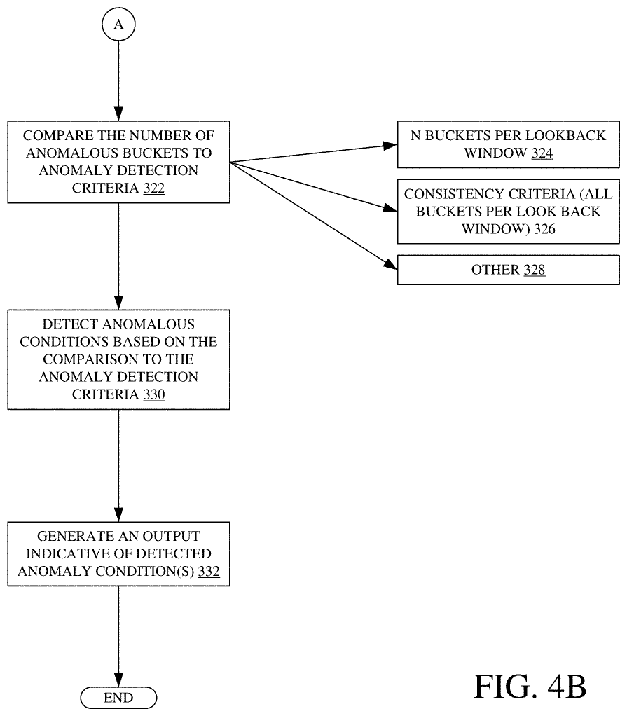

Threshold comparison system 168 then compares the detected metric (e.g., a representative metric) to the dynamic anomaly detection threshold to determine whether an anomaly is occurring, and a time over which it has occurred. This is indicated by block 266 in the flow diagram of FIG. 3. Comparing the detected metric against the dynamic anomaly detection threshold is also described in greater detail below with respect to FIG. 4.

If an anomaly condition exists, as indicated by block 268, then anomaly detector 170 detects this based upon the comparison of the metric value to the dynamic anomaly detection threshold. Anomaly detector 170 provides an output indicating that an anomaly is present, to anomaly severity level identification system 172. System 172 classifies the anomaly based on its severity level. This is indicated by block 270. For instance, the severity level can be based on a relative magnitude of the anomaly (how far the metric value deviates from the dynamic anomaly detection threshold). This is indicated by block 272. The severity level can be based on how long the anomaly has lasted, as indicated by block 274. The severity level of the anomaly can be based on a wide variety of other criteria as well, and this is indicated by block 276.

Action signal generator 148 then identifies an action to take based on the anomaly and the severity level. This is indicated by block 278. It generates control signals to control remote server computing system 102 to perform the action. This is indicated by block 280. For instance, control signal generator 150 can generate control signals to control the computing system 102 to automatically perform remediary actions on the server side. This is indicated by block 282, and may include such things as reallocating computing resources, trouble shooting resources, etc. Generating signals to allocate more resources is indicated by block 284. Alert generator 152 can generate control signals to surface an alert for an engineer or other user who may perform additional remedial actions. This is indicated by block 286. For instance, alert generator 152 can generate control signals to control communication system 140 to send an alert to other computing systems 110 where they can be surfaced for an engineer or other user. The alert may identify the type of the anomaly, the place where the anomaly is occurring, the specific client machine or set of machines or tenant(s) that gave rise to the anomaly, among other things. Action signal generator 148 can generate a wide variety of other action signals to perform a wide variety of other actions as well. This is indicated by block 288.

The engineers or other personnel that evaluate the anomaly can also provide feedback through feedback system 152. The feedback may indicate that the anomaly detection is correct, that the level was correct or incorrect, or that the anomaly detection, itself, was incorrect. Detecting this type of feedback is indicated by block 290. Machine learning system 144 then performs machine learning based on the feedback. This is indicated by block 292. The machine learning can be used to modify the constants, relative values, or other values or functions in Equations 1 and 2 above to improve the accuracy of machine learning anomaly detection system 146 in detecting anomalies and/or identifying the severity level of the anomalies.

FIGS. 4A and 4B (collectively referred to herein as FIG. 4) show a flow diagram illustrating one example of the operation of machine learning anomaly detection system 146 in comparing a detected metric to the dynamic anomaly detection threshold to determine whether an anomaly exists. Thus, FIGS. 4A and 4B show the operation identified at block 266 in FIG. 3, in more detail.

Instead of simply identifying an anomalous metric value, it may desirable to detect an anomaly based on its impact. One indication of the impact of an anomaly is how long the anomaly lasts. Therefore, instead of simply checking a given data point against the dynamic anomaly threshold to identify an anomaly, it may be desirable to detect an anomaly based on a set of time series data. In one example, the time series of data is thus evaluated over a time window, referred to as a lookback window. Lookback windows/bucket identifier 188 can identify the length of the lookback window over which data is evaluated, in order to identify an anomaly, as constant or based on volume, or it may vary the lookback window in other ways. Identifying the lookback window is indicated by block 300 in the flow diagram of FIG. 4. Using a constant lookback window is indicated by block 302, and identifying the lookback window based on data volume is indicted by block 304. Lookback window/bucket identifier 188 may identify the lookback window in other ways as well, and this is indicated by block 306.

In one example, identifier 188 then divides the lookback window into buckets of time. The health of each bucket is then evaluated by generating a representative value, that represents the time series metrics in the bucket, and comparing that representative value against the dynamic anomaly detection threshold. The length of each bucket (the size of each bucket in terms of time) can be determined based upon a desired granularity for determining system health, or in other ways. Having lookback window/bucket identifier 188 divide the lookback window into segments or buckets is indicated by block 308 in the flow diagram of FIG. 4.

Bucket selection component 190 then selects one of the buckets for evaluation. This is indicated by block 310. Metric per bucket generator 202 then generates a representative metric for the selected bucket. For instance, where the metrics are representative of connectivity (e.g., connection success rate), then an average value for the connectivity can be generated for the selected bucket. Generating a representative value for the selected bucket is indicated by block 312.

Recall that volume per bucket detector 192 has detected the data volume in the present bucket. Therefore, function application component 198 has also generated a value for the anomaly detection threshold, given that volume. The representative value for the metric under analysis, for the selected bucket, is then compared by metric/threshold comparison component 204, to the dynamic anomaly detection threshold. This is indicated by block 314. The result of that comparison is provided to anomaly detector 170 which determines whether the value for the metric under analysis crosses the anomaly detection threshold. This is indicated by block 316. If not, then no anomaly currently exists and this selected bucket is not an anomalous bucket. However, if the metric representing the values in the selected bucket does cross the dynamic anomaly detection threshold, then anomalous bucket identifier 208 marks the selected bucket as an anomalous bucket. This is indicated by block 318.

If there are more buckets in the present lookback window, then processing reverts to block 310 where bucket selection component 190 selects the next bucket, metric per bucket generator 202 generates a representative value for that bucket, comparison component 204 compares the representative value against the anomaly detection threshold that is calculated based upon the volume in that bucket, and anomalous bucket identifier determines whether the selected bucket is anomalous. Returning to block 310 to select another bucket is indicated by block 320 in the flow diagram of FIG. 4.

Anomaly detection criteria comparison system 210 then detects the number of anomalous buckets in the lookback window against the anomaly detection criteria to determine whether an anomaly has been detected. This is indicated by block 322 in the flow diagram of FIG. 4. As discussed above, it may be that an anomaly will be detected when one or more (or any pre-defined number or proportion) of the buckets in the lookback window are identified as anomalous. This is indicated by block 324 in the flow diagram of FIG. 4. In another example, it may be that an anomaly will only be detected when the anomaly is relatively persistent (such as when all of the buckets in the lookback window are identified as anomalous). This is indicated by block 326 in the flow diagram of FIG. 4. It will be noted that anomaly detection criteria comparison system 210 can compare the number of anomalous buckets in the lookback window against other criteria as well, in order to determine whether an anomaly has been detected. This is indicated by block 328.

Also, anomaly detector 170 can detect other conditions giving context to the detected anomaly. This is indicated by block 330. For instance, the anomalous conditions may identify a client system where the anomaly is detected, a network or network path corresponding to the anomaly (such as, for instance, when the operational persistence represented by the sensed metrics is latency), the consistency of the anomaly (such as indicated by the number of anomalous buckets in the lookback window) or any of a wide variety of other anomalous conditions.

When the anomalous conditions are detected, an output indicative of this is provided from anomaly detector 170 to anomaly severity level identification system 172 where the anomaly is classified (as discussed above with respect to block 270 in the flow diagram of FIG. 3). Generating an output indicative of the detected anomaly conditions is indicated by block 332 in the flow diagram of FIG. 4.

An example of generating a dynamic anomaly detection threshold, and applying it to a representative metric value will now be described. With the present example, it is assumed that the time series of metric values represent values indicative of the percent of successful connectivity requests that are attempted by a client computing system 104, in an attempt to connect to the service hosted by remote server computing system 102.

It is first assumed that the values in the time series that are being analyzed have a normal distribution over the history window that is being used for analysis. It is also assumed that the normal distribution has a mean value μ=99.0, and a standard deviation σ=0.5. it is further assumed that the mean of the volume of the number of requests in the last week, Mean (last_week_vol)=1500. In order to calculate the dynamic anomaly detection threshold, it is assumed that the constant c=3.5 and the constant b=1000. Under these assumptions, the dynamic anomaly detection threshold can be calculated, according to Equation 1, as follows:

$$DynamicThreshold = μ - ( 3.5 + {e}^{- \frac{vol}{1000}} + {e}^{- \frac{vol}{1500}} ) * σ \qquad Eq . 5$$

Next, Equation 5 can be evaluated for two different volumes (vol=500 and vol=3000). Recall that these volume numbers represent the volume of metrics in each bucket under analysis in the lookback window described above. This may correspond to detecting anomalies at a higher volume time of day (e.g., during working hours where volume=3000) and detecting anomalies at a low volume time of day (e.g., during night times hours where volume=500). Evaluating Equation 5 under these circumstances provides the following:

$$= \{ \begin{matrix}μ - 4.8 * σ = 96.6 when vol = 500 \\ μ - 3.7 * σ = 97.15 when vol = 3000\end{matrix} \} \qquad Eq . 6$$

This can be compared to a static threshold which may be set. For instance, assuming that the static threshold is set for the mean plus or minus four standard deviations yields a static threshold as follows:

StaticThreshold=μ−4*σ=97 Eq. 7

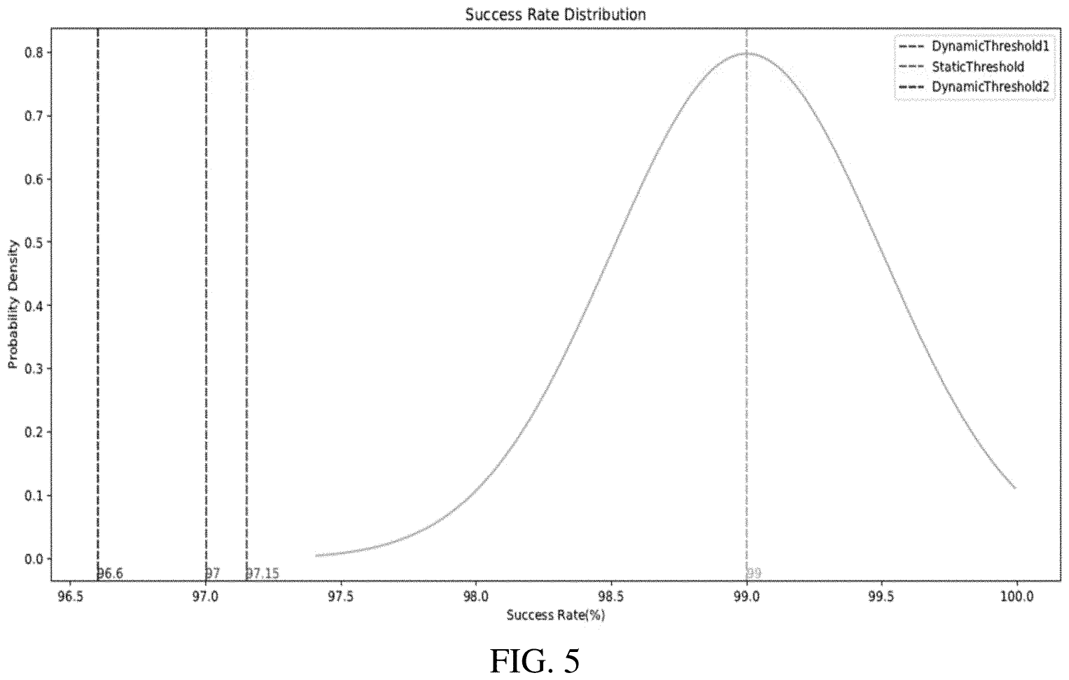

FIG. 5 illustrates one example of a distribution graph showing the normal distribution of the time series of values in the present example. The static threshold value (being 97) is used for instances of all different request volumes. However, the dynamic anomaly detection threshold varies. For instance, when the request volume is 500, which is a relatively low volume, then the corresponding dynamic anomaly detection threshold is approximately 96.6, which is further away from the mean success rate than the static threshold. When the request volume is 3000, which is a relatively high volume, then the dynamic anomaly detection threshold is 97.15, which is closer to the mean value than the static threshold. Thus, the dynamic threshold assumes a different value, based upon the real-time request volume, to make better decisions as to whether an anomaly is actually occurring.

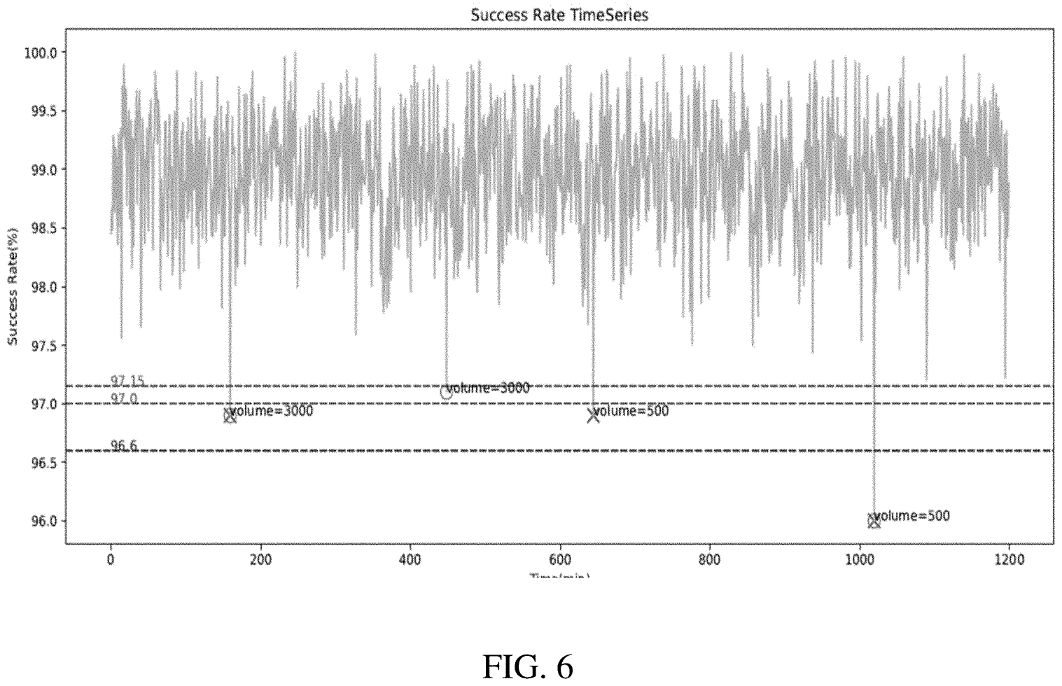

Given these anomaly detection threshold values, now assume a time series of requests that connection request success rate as shown in FIG. 6. It can be seen that the connection success rate is generally around 99.0% and the request volume varies in weekly cycles, which are generally aligned with working hours. In the success rate time series illustrated in FIG. 6, there are four dips which have the volume, at each dip, labeled. The first two dips in the connection success rate correspond to a connection volume of 3000, while the next two dips correspond to a request volume of 500.

When using the static threshold calculated above (of 97), then the first, third and fourth dips are identified as anomalies. This is because all three dips have a connection success rate that is less than 97.

Using the dynamic thresholds calculated above, the first second and fourth dips are identified as anomalies because the first and second dips cross the dynamic anomaly detection threshold of 97.15 (which was calculated for large volumes of 3000 requests), and the fourth dip crosses the dynamic anomaly detection threshold of 96.6 (which was calculated for lower volumes of approximately 500 requests).

The table below shows the difference in performance between using a static anomaly detection threshold and a dynamic anomaly detection threshold, which varies based on a current volume.

TABLE 1

| | 1^{st} | 2^{nd} | 3^{rd} | 4^{th} | | | |
|---|---|---|---|---|---|---|---|
| | dip | dip | dip | dip | True | False | |
| IsRealAnomaly | Yes | Yes | No | Yes | Positive | Positive | Precision |
| Static threshold | ✓ | | ✓ | ✓ | 2 | 1 | 2/3 |
| Dynamic | ✓ | ✓ | | ✓ | 3 | 0 | 1 |
| threshold | | | | | | | |

Table 1 shows that the dynamic anomaly detection threshold is more accurate in identifying real anomalies that have some temporal impact. The first, second and fourth dips are identified as anomalies, whereas the dynamic anomaly detection threshold ignores, as noise, the third dip, which is likely caused by a slight fluctuation, but occurs at a relatively low request volume. By contrast, using the static threshold causes the system to mischaracterize the third dip as an anomaly and to leave the second dip undetected.

It can thus be seen that, by using a dynamic anomaly detection threshold, which varies based on volume, the present description provides a system which is more accurate and more efficient in identifying anomalous operational characteristics in the computing system architecture. This results in more accurate computing system performance and also increases efficiency, in that false anomalies are not identified.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

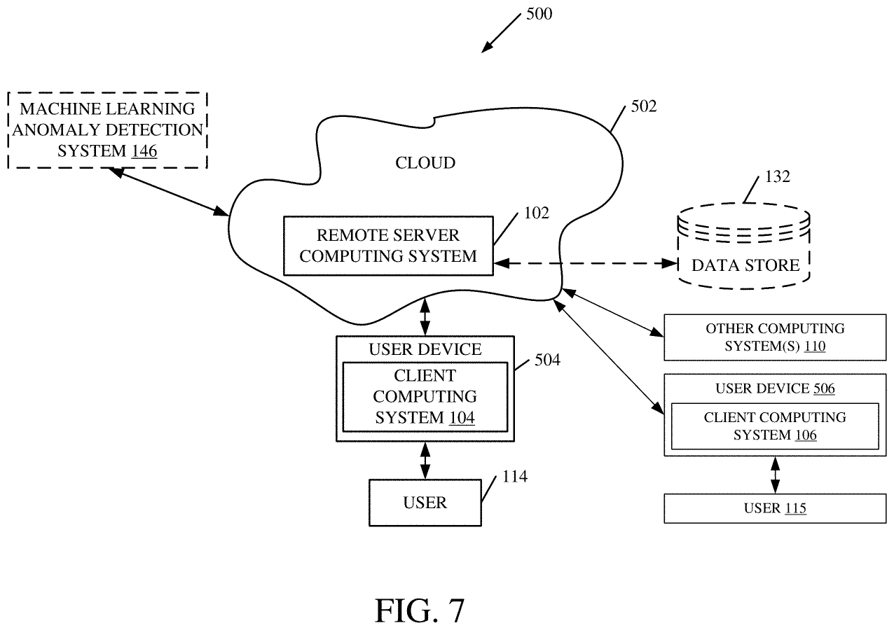

FIG. 7 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 7, some items are similar to those shown in FIG. 1 and they are similarly numbered. FIG. 7 specifically shows that remote server computing system 102 can be located in cloud 502 (which can be public, private, or a combination where portions are public while others are private). Therefore, users 114 and 115 use user devices 504 and 506 to access those systems through cloud 502.

FIG. 7 also depicts another example of a cloud architecture. FIG. 7 shows that it is also contemplated that some elements of computing system 102 can be disposed in cloud 502 while others are not. By way of example, data store 132 can be disposed outside of cloud 502, and accessed through cloud 502. In another example, machine learning anomaly detection system 146 (or other items) can be outside of cloud 502. Regardless of where they are located, they can be accessed directly by devices 504 and 506, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

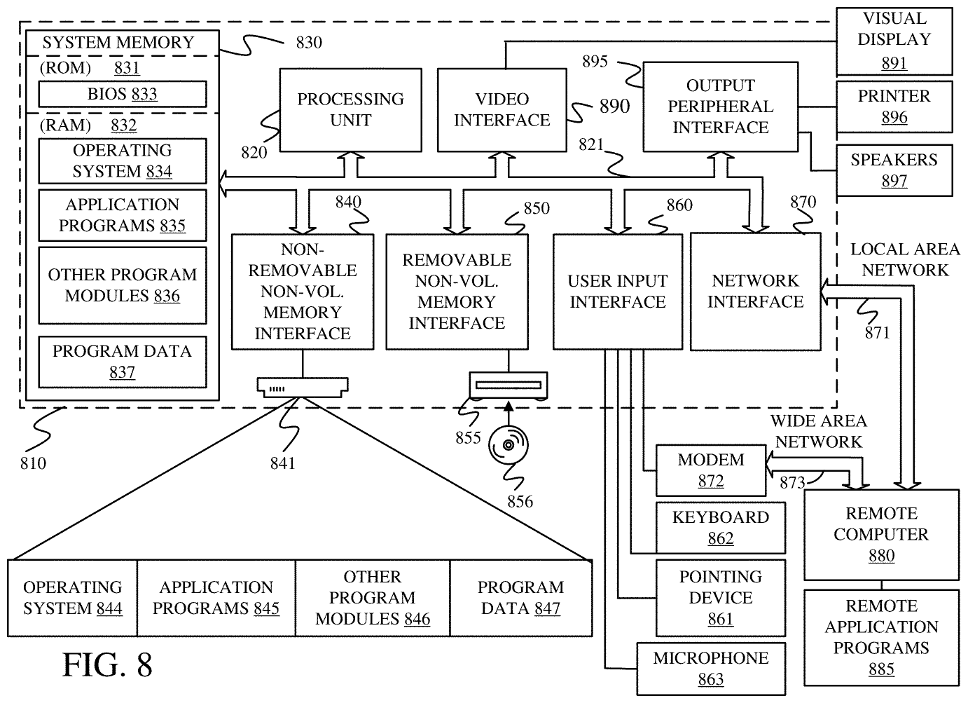

FIG. 8 is one example of a computing environment in which architecture 100, or parts of it, (for example) can be deployed. With reference to FIG. 8, an example system for implementing some embodiments includes a computing device in the form of a computer 810 programmed to operate as discussed above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer implemented method for detect anomalous behavior in operational characteristics of a computing system, the method comprising:

receiving, at an anomaly detection system, a time series of metrics, each metric in the time series of metrics being indicative of a detected computing system event within a time window under analysis;

detecting an event volume indicative of a volume of computing system events represented by the time series of metrics;

applying, with a processor, a dynamic anomaly detection threshold generator to generate a dynamic anomaly detection threshold that varies based on the event volume and based on distribution parameters characterizing a distribution of metric values over a historic time window that is larger than the time window under analysis;

comparing a representative value, representative of the metrics in the time window under analysis, to the dynamic anomaly detection threshold to obtain a comparison result signal;

detecting an anomaly in the operational characteristics of the computing system based on the comparison result signal; and

generating an action signal to control a portion of the computing system based on the detected anomaly.

Example 2 is the computer implemented method of any or all previous examples and further comprising:

detecting feedback indicative of an accuracy in detecting the anomaly; and

performing machine learning to modify the dynamic anomaly detection threshold based on the feedback.

Example 3 is the computer implemented method of any or all previous examples wherein detecting an anomaly comprises:

accessing anomaly detection criteria; and

applying the anomaly detection criteria to the comparison result to determine whether an anomaly is detected.

Example 4 is the computer implemented method of any or all previous examples wherein the anomaly detection criteria comprise persistence criteria and wherein detecting an anomaly comprises:

identifying a persistence time period over which the anomaly persisted;

comparing the persistence time period to the persistence criteria; and

detecting the anomaly when the persistence time period meets the persistence criteria.

Example 5 is the computer implemented method of any or all previous examples and further comprising:

detecting an anomaly severity level based on a persistence of the anomaly indicated by the comparison of the persistence time period to the persistence criteria.

Example 6 is the computer implemented method of any or all previous examples wherein generating an action signal comprises:

generating the actions signal based on the detected anomaly severity level.

Example 7 is the computer implemented method of any or all previous examples wherein applying a dynamic anomaly detection threshold generator to generate a dynamic anomaly detection threshold comprises:

applying a dynamic anomaly detection threshold generator to generate a dynamic anomaly detection threshold that decreases as the event volume decreases, and increases as the event volume increases.

Example 8 is the computer implemented method of any or all previous examples wherein comparing a representative value, representative of the metrics in the time window under analysis, to the dynamic anomaly detection threshold to obtain a comparison result signal comprises dividing the time window under analysis into a plurality of temporal segments, and wherein detecting an event volume comprises:

selecting a temporal segment; and

detecting an event volume in the selected temporal segment.

Example 9 is the computer implemented method of any or all previous examples wherein applying the anomaly detection threshold generator comprises:

applying the dynamic anomaly detection threshold generator to generate a dynamic anomaly detection threshold for the selected temporal segment that varies based on the event volume in the selected temporal segment and based on distribution parameters characterizing a distribution of metric values over the historic time window that is larger than the selected temporal segment.

Example 10 is the computer implemented method of any or all previous examples wherein comparing comprises:

generating the representative value as representative of the metric values in the selected temporal segment; and

comparing the representative value to the dynamic anomaly detection threshold for the selected temporal segment.

Example 11 is the computer implemented method of any or all previous examples wherein detecting an anomaly comprises:

identifying the temporal segment as an anomalous segment based on the comparison of the representative value to the dynamic anomaly detection threshold for the selected temporal segment.

Example 12 is the computer implemented method of any or all previous examples wherein detecting an anomaly comprises:

detecting the anomaly based on a number of the temporal segments in the window under analysis are anomalous segments.

Example 13 is a computer implemented method for detect anomalous behavior in operational characteristics of a computing system, the method comprising:

receiving a time series of metrics, each metric in the time series of metrics being indicative of a detected computing system event within a time window under analysis;

identifying an event volume indicative of a volume of computing system events represented by the time series of metrics in the time window under analysis;

applying a dynamic anomaly detection threshold generator to generate a dynamic anomaly detection threshold that varies based on the event volume and based on distribution parameters characterizing a distribution of metric values over a historic time window that is larger than the time window under analysis;

comparing a representative value, representative of the metrics in the time window under analysis, to the dynamic anomaly detection threshold to obtain a comparison result signal indicative of whether the representative value meets the dynamic anomaly detection threshold;

if the representative value meets the dynamic anomaly detection threshold, detecting a time period over which the representative value meets the dynamic anomaly detection threshold, to obtain a persistence value;

identifying an anomaly in the operational characteristics of the computing system based on the comparison result signal and the persistence value; and

generating an action signal to control a portion of the computing system based on the identified anomaly.

Example 14 is the computer implemented method of any or all previous examples and further comprising:

detecting feedback indicative of an accuracy in identifying the anomaly; and

performing machine learning to modify the dynamic anomaly detection threshold based on the feedback.

Example 15 is the computer implemented method of any or all previous examples wherein applying a dynamic anomaly detection threshold generator to generate a dynamic anomaly detection threshold comprises:

applying a dynamic anomaly detection threshold generator to generate a dynamic anomaly detection threshold that decreases, as the event volume in the time window under analysis decreases, and increases, as the event volume in the window under analysis increases.

Example 16 is a computer system, comprising:

a communication system that receives a time series of metrics, each metric in the time series of metrics being indicative of a detected computing system event within a time window under analysis;

a volume detector that identifies an event volume indicative of a volume of computing system events represented by the time series of metrics in the time window under analysis;

a dynamic anomaly detection threshold generator that receives the event volume and generates a dynamic anomaly detection threshold that varies based on the event volume and based on distribution parameters characterizing a distribution of metric values over a historic time window that is larger than the time window under analysis;

a threshold comparison system that compares a representative value, representative of the metrics in the time window under analysis, to the dynamic anomaly detection threshold to obtain a comparison result signal indicative of whether the representative value meets the dynamic anomaly detection threshold;

an anomaly detector that receives the comparison result signal and detects an anomaly in the operational characteristics of the computing system based on the comparison result signal; and

an action signal generator that generates an action signal to control a portion of the computing system based on the detected anomaly.

Example 17 is the computer system of any or all previous examples and further comprising:

a feedback system that detects feedback indicative of an accuracy of the anomaly detector; and

a machine learning system that performs machine learning to modify the dynamic anomaly detection threshold generator based on the feedback.

Example 18 is the computing system of any or all previous examples wherein the dynamic anomaly detection threshold generator comprises:

an absolute comparison value identifier that identifies a volume constant;

a historical volume comparison value identifier that identifies a historical volume level; and

a function application component that compares the event volume to the volume constant to obtain an absolute volume indicator and that compares the event volume to the historical volume level to obtain a relative volume indicator and that generates the dynamic anomaly detection threshold using a function that decreases, as the event volume in the time window under analysis decreases, and increases, as the event volume in the window under analysis increases, based on the absolute volume indicator and the relative volume indicator.

Example 19 is the computing system of any or all previous examples wherein the anomaly detector comprises:

an anomaly detection criteria comparison system that detects a time period over which the representative value meets the dynamic anomaly detection threshold, to obtain a persistence value, and identifies an anomaly in the operational characteristics of the computing system based on the comparison result signal and the persistence value.

Example 20 is the computing system of any or all previous examples wherein the action signal generator comprises:

an alert generator that generates an alert based on the detected anomaly.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for detect anomalous behavior in operational characteristics of a computing system, the method comprising:
receiving, at an anomaly detection system, a time series of metrics, each metric in the time series of metrics being indicative of a detected computing system event within a time window under analysis;
detecting an event volume indicative of a volume of computing system events represented by the time series of metrics;
applying, with a processor, a dynamic anomaly detection threshold generator to generate a dynamic anomaly detection threshold that varies based on the event volume and based on distribution parameters characterizing a distribution of metric values over a historic time window that is larger than the time window under analysis;
comparing a representative value, representative of the metrics in the time window under analysis, to the dynamic anomaly detection threshold to obtain a comparison result signal;
detecting an anomaly in the operational characteristics of the computing system based on the comparison result signal; and
generating an action signal to control a portion of the computing system based on the detected anomaly.

2. The computer implemented method of claim 1 and further comprising:
detecting feedback indicative of an accuracy in detecting the anomaly; and
performing machine learning to modify the dynamic anomaly detection threshold based on the feedback.

3. The computer implemented method of claim 1 wherein detecting an anomaly comprises:
accessing anomaly detection criteria; and
applying the anomaly detection criteria to the comparison result to determine whether an anomaly is detected.

4. The computer implemented method of claim 3 wherein the anomaly detection criteria comprise persistence criteria and wherein detecting an anomaly comprises:
identifying a persistence time period over which the anomaly persisted;
comparing the persistence time period to the persistence criteria; and
detecting the anomaly when the persistence time period meets the persistence criteria.

5. The computer implemented method of claim 4 and further comprising:
detecting an anomaly severity level based on a persistence of the anomaly indicated by the comparison of the persistence time period to the persistence criteria.

6. The computer implemented method of claim 5 wherein generating an action signal comprises:
generating the actions signal based on the detected anomaly severity level.

7. The computer implemented method of claim 1 wherein applying a dynamic anomaly detection threshold generator to generate a dynamic anomaly detection threshold comprises:
applying a dynamic anomaly detection threshold generator to generate a dynamic anomaly detection threshold that decreases as the event volume decreases, and increases as the event volume increases.

8. The computer implemented method of claim 1 wherein comparing a representative value, representative of the metrics in the time window under analysis, to the dynamic anomaly detection threshold to obtain a comparison result signal comprises dividing the time window under analysis into a plurality of temporal segments, and wherein detecting an event volume comprises:
selecting a temporal segment; and
detecting an event volume in the selected temporal segment.

9. The computer implemented method of claim 8 wherein applying the anomaly detection threshold generator comprises:
applying the dynamic anomaly detection threshold generator to generate a dynamic anomaly detection threshold for the selected temporal segment that varies based on the event volume in the selected temporal segment and based on distribution parameters characterizing a distribution of metric values over the historic time window that is larger than the selected temporal segment.

10. The computer implemented method of claim 9 wherein comparing comprises:
generating the representative value as representative of the metric values in the selected temporal segment; and
comparing the representative value to the dynamic anomaly detection threshold for the selected temporal segment.

11. The computer implemented method of claim 10 wherein detecting an anomaly comprises:
identifying the temporal segment as an anomalous segment based on the comparison of the representative value to the dynamic anomaly detection threshold for the selected temporal segment.

12. The computer implemented method of claim 11 wherein detecting an anomaly comprises:
detecting the anomaly based on a number of the temporal segments in the window under analysis are anomalous segments.

13. A computer implemented method for detect anomalous behavior in operational characteristics of a computing system, the method comprising:
receiving a time series of metrics, each metric in the time series of metrics being indicative of a detected computing system event within a time window under analysis;
identifying an event volume indicative of a volume of computing system events represented by the time series of metrics in the time window under analysis;
applying a dynamic anomaly detection threshold generator to generate a dynamic anomaly detection threshold that varies based on the event volume and based on distribution parameters characterizing a distribution of metric values over a historic time window that is larger than the time window under analysis;
comparing a representative value, representative of the metrics in the time window under analysis, to the dynamic anomaly detection threshold to obtain a comparison result signal indicative of whether the representative value meets the dynamic anomaly detection threshold;
if the representative value meets the dynamic anomaly detection threshold, detecting a time period over which the representative value meets the dynamic anomaly detection threshold, to obtain a persistence value;
identifying an anomaly in the operational characteristics of the computing system based on the comparison result signal and the persistence value; and
generating an action signal to control a portion of the computing system based on the identified anomaly.

14. The computer implemented method of claim 13 and further comprising:
detecting feedback indicative of an accuracy in identifying the anomaly; and
performing machine learning to modify the dynamic anomaly detection threshold based on the feedback.

15. The computer implemented method of claim 14 wherein applying a dynamic anomaly detection threshold generator to generate a dynamic anomaly detection threshold comprises:
applying a dynamic anomaly detection threshold generator to generate a dynamic anomaly detection threshold that decreases, as the event volume in the time window under analysis decreases, and increases, as the event volume in the window under analysis increases.

16. A computer system, comprising:
a communication system that receives a time series of metrics, each metric in the time series of metrics being indicative of a detected computing system event within a time window under analysis;
a volume detector that identifies an event volume indicative of a volume of computing system events represented by the time series of metrics in the time window under analysis;
a dynamic anomaly detection threshold generator that receives the event volume and generates a dynamic anomaly detection threshold that varies based on the event volume and based on distribution parameters characterizing a distribution of metric values over a historic time window that is larger than the time window under analysis;
a threshold comparison system that compares a representative value, representative of the metrics in the time window under analysis, to the dynamic anomaly detection threshold to obtain a comparison result signal indicative of whether the representative value meets the dynamic anomaly detection threshold;
an anomaly detector that receives the comparison result signal and detects an anomaly in the operational characteristics of the computing system based on the comparison result signal; and
an action signal generator that generates an action signal to control a portion of the computing system based on the detected anomaly.

17. The computer system of claim 16 and further comprising:
a feedback system that detects feedback indicative of an accuracy of the anomaly detector; and
a machine learning system that performs machine learning to modify the dynamic anomaly detection threshold generator based on the feedback.

18. The computing system of claim 17 wherein the dynamic anomaly detection threshold generator comprises:
an absolute comparison value identifier that identifies a volume constant;
a historical volume comparison value identifier that identifies a historical volume level; and
a function application component that compares the event volume to the volume constant to obtain an absolute volume indicator and that compares the event volume to the historical volume level to obtain a relative volume indicator and that generates the dynamic anomaly detection threshold using a function that decreases, as the event volume in the time window under analysis decreases, and increases, as the event volume in the window under analysis increases, based on the absolute volume indicator and the relative volume indicator.

19. The computing system of claim 18 wherein the anomaly detector comprises:
an anomaly detection criteria comparison system that detects a time period over which the representative value meets the dynamic anomaly detection threshold, to obtain a persistence value, and identifies an anomaly in the operational characteristics of the computing system based on the comparison result signal and the persistence value.

20. The computing system of claim 19 wherein the action signal generator comprises:
an alert generator that generates an alert based on the detected anomaly.
